(19) United States
(12) Patent Application Publication
(10) Pub. No.: US 2026/0367558 A1
(43) Pub. Date: Nov. 19, 2026

(54) EXPOSURE APPARATUS AND IMAGE-FORMING APPARATUS

(71) Applicant: CANON KABUSHIKI KAISHA, Tokyo (JP)

(72) Inventor: YASUTOMO FURUTA, Chiba (JP)

(21) Appl. No.: 19/672,834

(22) Filed: May 11, 2026

(30) Foreign Application Priority Data
May 19, 2025 (JP) 2025-083514

(51) Int. Cl. G03G 15/00; G03G 15/04; G03G 15/043

(52) U.S. Cl. CPC G03G 15/5033; G03G 15/04054; G03G 15/043; G03G 2215/0409; G03G 2215/0412; G03G 2215/0429

(57) ABSTRACT

An exposure apparatus includes a light-emitting element array arranged parallel to the rotation axis of a photosensitive member. A generation unit generates correction data indicating a correction amount determined for each image region to suppress image unevenness. A correction unit modifies the correction data based on a limit value to correct pixel values. A light emission control unit then manages light emission based on the corrected data. In a case where a correction amount of a first image region exceeds the limit value, the correction unit modifies the correction amount of the first image region to a value not exceeding the limit value, and further modifies correction amounts of one or more other image regions including an adjacent image region of the first image region in accordance with the modification to the correction amount of the first image region.

### BACKGROUND

### Field of the Technology

The present disclosure relates to an exposure apparatus and an image-forming apparatus.

### Description of the Related Art

As an exposure apparatus used in an electrophotographic type image-forming apparatus, an exposure apparatus employing a solid-state exposure system is commonly known, in which a photosensitive member is exposed to light emitted by LEDs (e.g. organic EL elements) instead of laser beam. This type of exposure apparatus includes a light-emitting element array including a plurality of light-emitting elements arranged at least in a direction that is parallel to a rotation axis of the photosensitive member, and a rod lens array that focuses light from the light-emitting element array on a surface of the photosensitive member. The exposure apparatus employing a solid-state exposure system is advantageous in that its miniaturization, improved quietness, and cost reduction are easier compared to an exposure apparatus employing a laser scanning system.

Japanese Patent Laid-Open No.2024-147996 discloses a method of correcting image data for light emission control to suppress unevenness of light intensity of a light-emitting element array in an exposure apparatus employing a solid-state exposure system. According to this method, a correction amount for each pixel position on image data is limited so as not to exceed a predetermined limit value, thereby preventing dot shape deformation due to excessive correction.

### SUMMARY

The present disclosure is directed to optimizing image quality of printed images in an exposure apparatus employing a solid-state exposure system.

One aspect of the present disclosure provides an exposure apparatus configured to expose a rotating photosensitive member to light in accordance with image data, the exposure apparatus comprising: a light-emitting element array that includes a plurality of light-emitting elements arranged at least in a first direction that is parallel to a rotation axis of the photosensitive member, a generation unit configured to generate correction data that indicates a correction amount determined for each image region of the image data such that image unevenness formed on the photosensitive member is suppressed, a correction unit configured to modify the correction data generated by the generation unit based on a predetermined limit value and correct pixel values of the image data in accordance with the modified correction data, and a light emission control unit configured to control light emission from each light-emitting element of the light-emitting element array in accordance with the image data corrected by the correction unit, wherein the correction unit is configured to, in a case where a correction amount of a first image region exceeds the limit value, modify the correction amount of the first image region into a value that does not exceed the limit value, and modify correction amounts of one or more other image regions including an adjacent image region of the first image region in accordance with the modification to the correction amount of the first image region.

Features of the present disclosure will become apparent from the following description of embodiments with reference to the attached drawings. The following description of embodiments is described by way of example.

### BRIEF DESCRIPTION OF THE DRAWINGS

FIG. 1 is a configuration diagram illustrating a schematic configuration of an image-forming apparatus according to an embodiment.

FIGS. 2A and 2B illustrate a configuration of a photosensitive member and an exposure head according to an embodiment.

FIGS. 3A and 3B illustrate a configuration of a printed circuit board of the exposure head according to an embodiment.

FIG. 4 illustrates an example of an arrangement of light-emitting elements in light-emitting chips according to an embodiment.

FIG. 5 is a partial cross-sectional view regarding an example of a configuration of a light-emitting element according to an embodiment.

FIG. 6 is a descriptive diagram regarding multiple exposure by light-emitting elements arranged in a staircase pattern.

FIG. 7 is a configuration diagram of a control circuit for controlling light emission of light-emitting chips on a printed circuit board.

FIGS. 8A to 8C are descriptive diagrams regarding a method of locally changing integrated exposure amount per unit area.

FIG. 9 is a graph representing an example of a measurement result of light intensity unevenness of a light-emitting element array along an axial direction of a photosensitive member.

FIG. 10 is a graph representing an example of a measurement result of density unevenness in a rotation direction of the photosensitive member.

FIG. 11 is a block diagram illustrating an example of a detailed configuration of a light intensity correction unit according to a certain embodiment.

FIG. 12 is a descriptive diagram illustrating an example of pre-modified correction data that indicates correction amounts determined such that image unevenness is suppressed.

FIG. 13 is a descriptive diagram illustrating an example of modified correction data in a first embodiment.

FIG. 14 is a descriptive diagram illustrating an example of modified correction data in a second embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### 1. Schematic Configuration of Image-Forming Apparatus

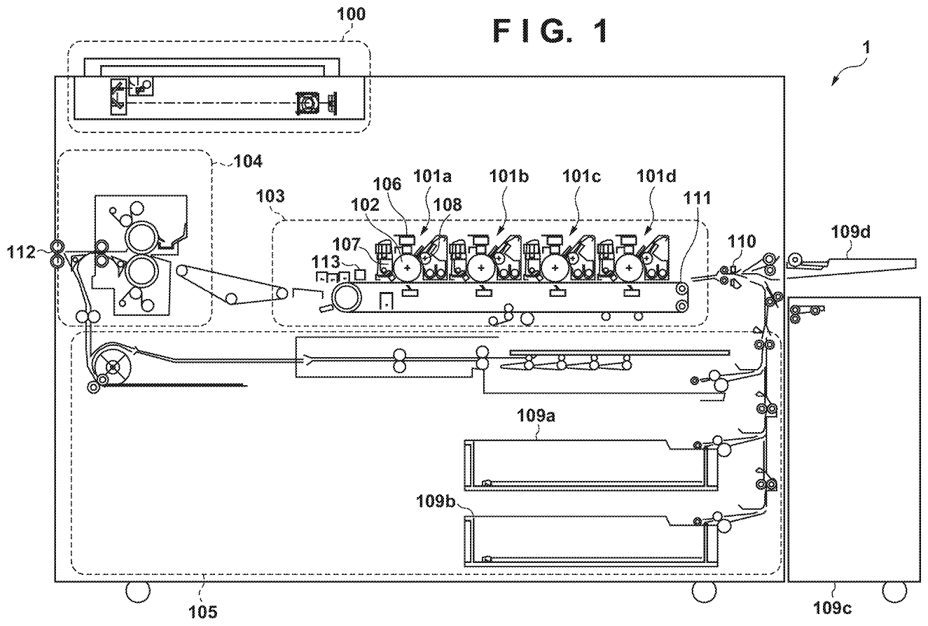

FIG. 1 shows an example of a schematic configuration of an image-forming apparatus 1 according to an embodiment. The image-forming apparatus 1 includes a reading unit 100, an image-forming section 103, a fixing unit 104, and a transport unit 105. The reading unit 100 optically reads an original document placed on a platen and generates read image data. The image-forming section 103 forms an image on a sheet based on the read image data generated by the reading unit 100 or based on print image data received from an external device via a network, for example.

The image-forming section 103 includes image-forming units 101a, 101b, 101c, and 101d. The image-forming units 101a, 101b, 101c, and 101d form toner images in black, yellow, magenta, and cyan, respectively. The image-forming units 101a, 101b, 101c and 101d have the same configuration, and are also referred to collectively as image-forming units 101 below. A photosensitive member 102 of the image-forming units 101 is driven to rotate in the clockwise direction in the figure during image formation. A charger 107 electrically charges the photosensitive member 102. An exposure head 106 exposes the photosensitive member 102 to light in accordance with image data to form an electrostatic latent image on a surface of the photosensitive member 102. A developer 108 develops the electrostatic latent image on the surface of the photosensitive member 102 with toner to form a toner image. The toner image formed on the surface of the photosensitive member 102 is transferred to a sheet that is being conveyed on a transfer belt 111. A full color image containing four color components, namely, black, yellow, magenta, and cyan can be formed by transferring the toner images formed on the four photosensitive members 102 to the sheet in a superimposed manner.

The transport unit 105 controls feeding and conveyance of sheets. Specifically, the transport unit 105 feeds a sheet from a unit designated from among internal storage units 109a and 109b, an external storage unit 109c, and a manual feed unit 109d to a conveyance path in the image-forming apparatus 1. The fed sheet is conveyed to a registration roller 110. The registration roller 110 conveys the sheet onto the transfer belt 111 at an appropriate timing so that the toner images of each photosensitive member 102 will be transferred to the sheet. As described above, the toner images are transferred to the sheet while the sheet is conveyed on the transfer belt 111. The fixing unit 104 fixes the toner images to the sheet by heating and pressurizing the sheet to which the toner images have been transferred. After the toner images have been fixed, the sheet is discharged to the outside of the image-forming apparatus 1 by a discharge roller 112. An optical sensor 113 is located at a position facing the transfer belt 111 in a downstream stage of the image-forming unit 101a. The optical sensor 113 is used to detect misalignment (color misalignment) between color components in a test image formed on the transfer belt 111 by the image-forming units 101. If color misalignment is detected, image-forming positions of the image-forming units 101a, 101b, 101c, and 101d are modified so as to compensate for the detected color misalignment under the control of an image controller 800 described below.

Although an example in which a toner image is directly transferred from each photosensitive member 102 to a sheet on the transfer belt 111 has been described here, a toner image may be indirectly transferred from each photosensitive member 102 to a sheet via an intermediate transfer member. Further, although an example of forming a color image using toner of multiple colors has been described here, the technology according to the present disclosure is also applicable to an image-forming apparatus that forms a monochrome image using toner of a single color.

### 2. Configuration Example of Exposure Head

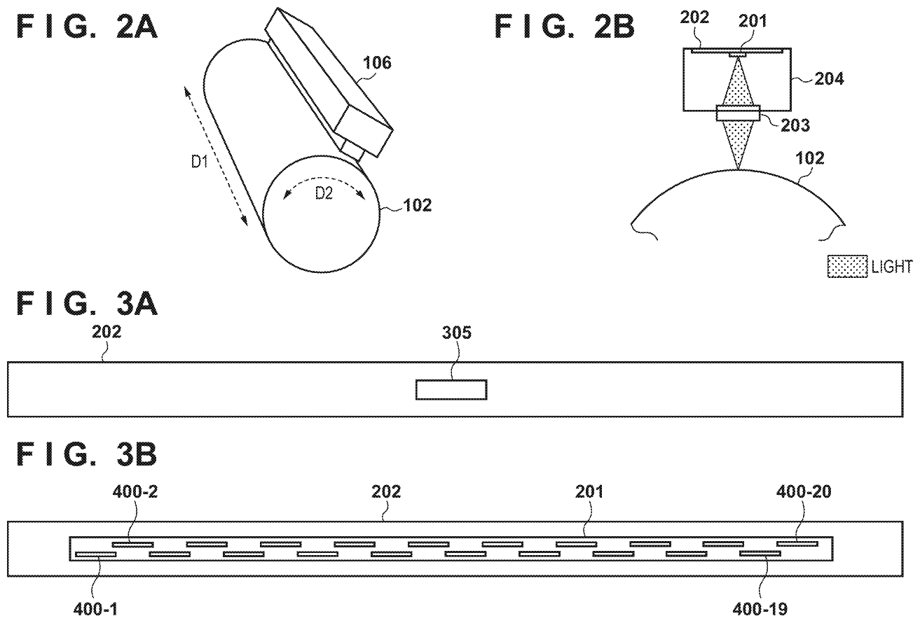

FIGS. 2A and 2B show a photosensitive member 102 and an exposure head 106. As described above, the exposure head 106 is an exposure apparatus that exposes a rotating photosensitive member 102 to light in accordance with image data. The exposure head 106 includes a light-emitting element array 201, a printed circuit board (also referred to as light-emitting board) 202 on which the light-emitting element array 201 is mounted, a rod lens array 203, and a housing 204 supporting the printed circuit board 202 and the rod lens array 203. The photosensitive member 102 has a cylindrical shape. The exposure head 106 is located such that the longitudinal direction thereof (first direction D1) is parallel to a rotation axis of the photosensitive member 102, and a surface of the exposure head 106 to which the rod lens array 203 is attached faces the surface of the photosensitive member 102. While the photosensitive member 102 rotates in a rotation direction (second direction D2) perpendicular to the rotation axis, the light-emitting element array 201 of the exposure head 106 emits light toward the photosensitive member 102, and the rod lens array 203 forms an image of the light on the surface of the photosensitive member 102.

Although not shown in FIGS. 2A and 2B, the image-forming apparatus 1 further includes a sensor system for the exposure head 106 to detect a phase of rotation of the photosensitive member 102. For example, the photosensitive member 102 has a reflective member that reflects light at a reference position that is outside an exposure region in the first direction D1 and serves as an origin for the phase of rotation in the second direction D2. On the other hand, the exposure head 106 has a pair of a light-emitting element and a light-receiving element at the same position in the first direction D1 as the reflective member of the photosensitive member 102. The light-receiving element detects light emitted from the light-emitting element and reflected by the reflective member when the reflective member of the photosensitive member 102 reaches a position facing the light-emitting element and light-receiving element of the exposure head 106 in one rotation cycle of the photosensitive member 102. Then, a sensor signal indicating a timing of detecting the reference position is output to the image controller 800 described below.

FIGS. 3A and 3B show an example of a configuration of the printed circuit board 202. Note that FIG. 3A shows a surface on which a connector 305 is mounted, and FIG. 3B shows a surface on which the light-emitting element array 201 is mounted (the surface opposite to the surface on which the connector 305 is mounted). In the present embodiment, the light-emitting element array 201 is constituted by twenty light-emitting chips 400-1 to 400-20, which are regularly arranged along the first direction D1. In the example of FIG. 3B, the light-emitting chips 400-1 to 400-20 are arranged in a staggered pattern. Specifically, ten light-emitting chips 400-i, where i is an odd number form one line, and the other ten light-emitting chips 400-i where i is an even number form another line. In this specification, the light-emitting chips 400 in the former line are also referred to as odd-numbered light-emitting chips 400, and the light-emitting chips 400 in the latter line are also referred to as even-numbered light-emitting chips 400. The light-emitting chips 400-1 to 400-20 are also referred to collectively as light-emitting chips 400. Each light-emitting chip 400 on the printed circuit board 202 is connected to the image controller 800 via the connector 305. In the following, for convenience of description, the side of the light-emitting chips 400-1 to 400-20 arranged along the first direction D1 with smaller suffixes may be referred to as “left” and the side with larger suffixes as “right”. For example, the light-emitting chip 400-1 is a light-emitting chip 400 at the left end, and the light-emitting chip 400-20 is a light-emitting chip at the right end.

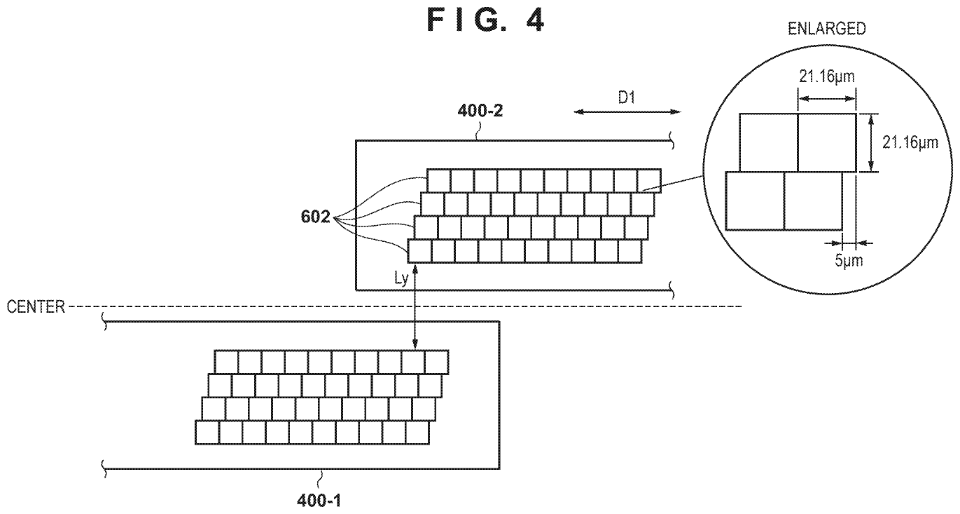

FIG. 4 illustrates an example of an arrangement of light-emitting elements 602 in the light-emitting chip 400. The light-emitting elements 602 in each light-emitting chip 400 are in a two-dimensional array forming K columns (K is an integer of 2 or more) in the first direction D1 and M rows (M is an integer of 2 or more) in the second direction D2. In an illustrative embodiment, K=748 and M=4; in this case, each light-emitting chip 400 has a total of 2992 (=748*4) light-emitting elements 602. In the entire light-emitting element array that includes 20 light-emitting chips 400, N=748*20=14960 light-emitting elements are arranged in the first direction D1. The pitch of light-emitting elements 602 adjoining in the first direction D1 may be approximately 21.16 μm, which corresponds to a resolution of 1200 dpi. In this case, the length of the entire light-emitting element array in the first direction D1 is approximately 316 mm (maximum width of a formable image area), and the length of each light-emitting chip 400 in the first direction D1 is approximately 15.8 mm. The M light-emitting elements in each column are shifted from each other in the first direction D1 at a pitch of approximately 5 μm, which corresponds to a resolution of 4800 dpi, and arranged in a staircase pattern. FIG. 4 shows an example in which the lower light-emitting element, out of two upper and lower light-emitting elements, is shifted to the left, but the lower light-emitting element may alternatively be shifted to the right. Further, the light-emitting elements in the right-end column of an odd-numbered light-emitting chip 400 and the light-emitting elements in the left-end column of an even-numbered light-emitting chip 400 may overlap with each other in the first direction D1, as shown in FIG. 4. Similarly, the light-emitting elements in the left-end column of an odd-numbered light-emitting chip 400 and the light-emitting elements in the right-end column of an even-numbered light-emitting chip 400 may also overlap with each other in the first direction D1. The spacing Ly between the arrays of the light-emitting elements of the light-emitting chips 400 may be, for example, approximately 105 μm. By thus arranging the arrays of the light-emitting elements in an overlapping manner in the first direction D1, it is possible to avoid a situation in which mounting variation results in voids within the exposable range. When such an overlapping arrangement is employed, normally, the light-emitting elements in only one of the overlapping columns are used as effective light-emitting elements that may emit light in accordance with image data. The light-emitting elements in the other column need not be used regardless of the image data. Note that the number of columns or light-emitting elements overlapping in the first direction D1 is not limited to the above example (one column and four pixels), and may be any number.

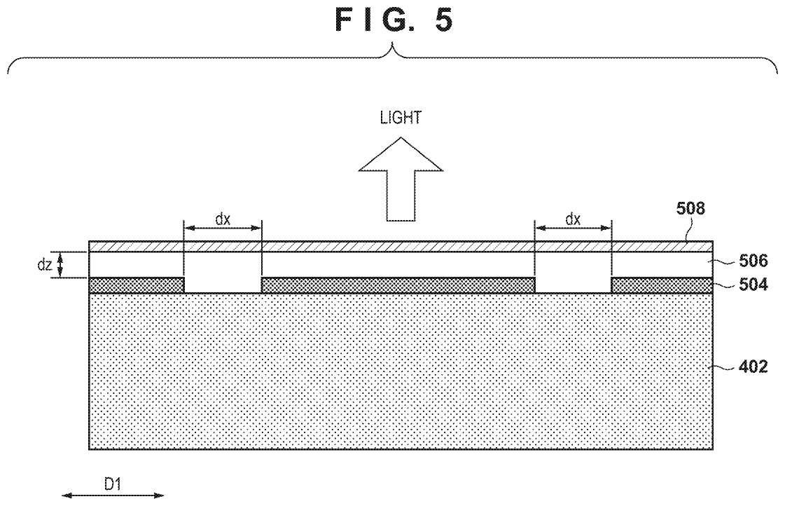

FIG. 5 is a partial cross-sectional view regarding an example of a configuration of each light-emitting element 602 formed on the light-emitting board 402 of the light-emitting element array. A plurality of lower electrodes 504 are formed on the light-emitting board 402. A light-emitting layer 506 is provided on the lower electrodes 504, and an upper electrode 508 is provided on the light-emitting layer 506. The upper electrode 508 is one common electrode for the plurality of lower electrodes 504. When a voltage is applied between the lower electrode 504 and the upper electrode 508, the light-emitting layer 506 emits light as a result of a current flowing from the lower electrode 504 to the upper electrode 508. Thus, one lower electrode 504 and a partial region of the light-emitting layer 506 and the upper electrode 508 that corresponds to the lower electrode 504 constitute one light-emitting element 602. “dx” in the figure indicates the distance between two adjoining lower electrodes 504. “dz” indicates the distance between the lower electrodes 504 and the upper electrode 508. Making dx larger than dz can suppress a leakage current between adjoining lower electrodes 504 and prevent a light-emitting element 602 that should not emit light from accidentally emitting light.

In the present embodiment, each light-emitting element 602 is configured as an organic electro-luminescence (EL) element. For example, an organic EL film can be used as the light-emitting layer 506. In another embodiment, each light-emitting element 602 may be configured as an inorganic EL element by using an inorganic EL film as the light-emitting layer 506. Generally, each light-emitting element 602 may be any type of light-emitting diode (LED).

The upper electrode 508 is a transparent electrode made of indium tin oxide (ITO) or the like, for example, so as to allow light of the emission wavelength of the light-emitting layer 506 to pass through. In the example of FIG. 5, the entire upper electrode 508 allows the light of the emission wavelength of the light-emitting layer 506 to pass through, but the entire upper electrode 508 does not necessarily need to allow the light to pass through. Specifically, it is sufficient that a portion through which light from each light-emitting element 602 is to pass through.

Note that, in FIG. 5, one continuous light-emitting layer 506 is formed, but a plurality of light-emitting layers 506 each having a width equal to the width of a corresponding lower electrode 504 may alternatively be formed on the respective lower electrodes 504. Further, in FIG. 5, the upper electrode 508 is formed as one common electrode for the plurality of lower electrodes 504, but a plurality of upper electrodes 508 each having a width equal to the width of a corresponding lower electrode 504 may alternatively be formed in correspondence with the respective lower electrodes 504. Further, a first plurality of lower electrodes 504, out of the lower electrodes 504 of each light-emitting chip 400, may be covered by a first light-emitting layer 506, and a second plurality of lower electrodes 504 may be covered by a second light-emitting layer 506. Similarly, a first upper electrode 508 may be formed in common for a first plurality of lower electrodes 504, out of the lower electrodes 504 of each light-emitting chip 400, and a second upper electrode 508 may be formed in common for a second plurality of lower electrodes 504. With such a configuration as well, one lower electrode 504 and a region of the light-emitting layer 506 and the upper electrode 508 that corresponds to the lower electrode 504 constitute one light-emitting element 602.

### 3. Multiple Exposure

While the use of organic EL elements as the light-emitting elements 602 facilitates miniaturization and cost reduction of the apparatus, the light intensity emitted by a single organic EL element may be insufficient to form an image with a desired density. The present embodiment adopts a multiple exposure technique that causes M light-emitting elements 602 in the second direction D2 to successively emit light during rotation of the photosensitive member 102, thereby subjecting one corresponding spot on the surface of the photosensitive member 102 to multiple exposure.

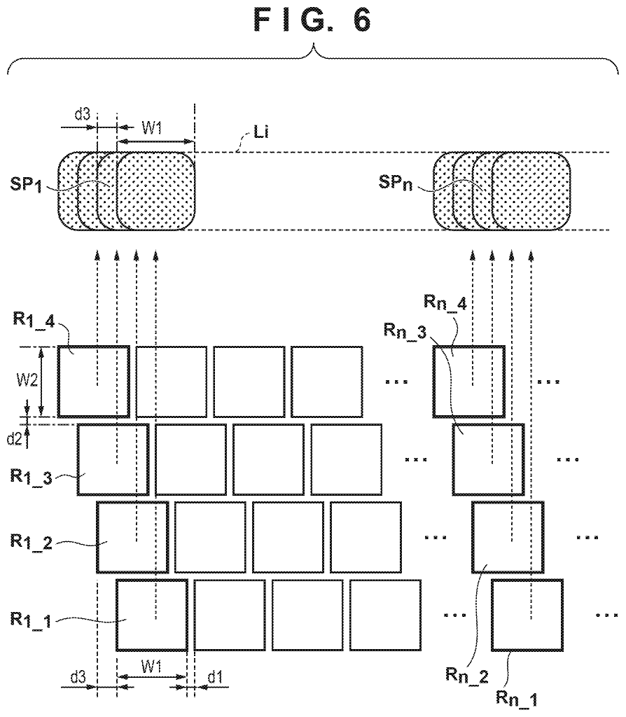

FIG. 6 is a descriptive diagram regarding the multiple exposure by light-emitting elements 602 arranged in a staircase pattern. In the present embodiment, M light-emitting elements 602 in each column of the light-emitting element array may be arranged in a staircase pattern at a constant pitch, as mentioned above. Here, an example of the arrangement of light-emitting elements in a case of M=4 is partially shown. R_{n_m} (n={1, 2, . . . , N}, m={1, 2, 3, 4}) in the figure represents a light-emitting element 602 in an n-th column from the left in the first direction D1 and an m-th row from the bottom in the second direction D2. “W1” in the figure denotes the width of each light-emitting element 602 in the first direction D1, and “W2” denotes the width of each light-emitting element 602 in the second direction D2. “d1” denotes the spacing between light-emitting elements 602 adjoining in the first direction D1, and “d2” denotes the spacing between light-emitting elements 602 adjoining in the second direction D2. d1 and d2 are obtained by expressing the above-described inter-electrode distance dx as divided along two coordinate axes, and both are determined so as to be wider than the distance dz between the upper electrode and the lower electrodes. The minimum pitch d3 of light-emitting elements 602 in the first direction D1 may be approximately 5 μm (equivalent to 4800 dpi), as mentioned above.

As four light-emitting elements in each column are arranged in a staircase pattern as in the example of FIG. 6, any two adjoining light-emitting elements among those four light-emitting elements occupy partially overlapping areas in the first direction D1. The four light-emitting elements in the column corresponding to each pixel position of the input image data successively emit light while the photosensitive member 102 rotates, thereby forming a spot corresponding to the pixel position on the surface of the photosensitive member 102. In the example of FIG. 6, when the leftmost pixel value of the i-th line of the input image data indicates that light emission is on, light-emitting elements R_{1_1}, R_{1_2}, R_{1_3}, and R_{1_4} successively emit light at timings when they respectively face line Lᵢ on the surface of the photosensitive member 102. As a result, the spot at the left end of the line Lᵢ is subjected to multiple exposure, and a corresponding spot SP₁ is formed. Similarly, when the n-th pixel value of the i-th line of the input image data indicates that light emission is on, light-emitting elements R_{n_1}, R_{n_2}, R_{n_3}, and R_{n_4} successively emit light at timings when they respectively face the line Lᵢ on the surface of the photosensitive member 102. As a result, the n-th spot from the left in the line Lᵢ is subjected to multiple exposure, and a corresponding spot SPₙ is formed. When the pitch of light-emitting elements in the second direction D2 is approximately 21.16 μm and the sheet conveyance speed is 200 mm/s, the period at which each line is exposed to light by one light-emitting element R_{n_m} (line period) may be approximately 105.8 μs. In this manner, as a result of four light-emitting elements in each column of twenty light-emitting chips 400 successively emitting light at appropriate timings, a smooth line of an electrostatic latent image that is constituted by a series of spots with a constant spot interval and partially overlap with each other may be formed on the surface of the photosensitive member 102. Then, a two-dimensional electrostatic latent image is produced as a result of such lines being continuously formed in the second direction D2.

### 4. Light Emission Control

### <4-1. Basic Configuration of Control Circuit>

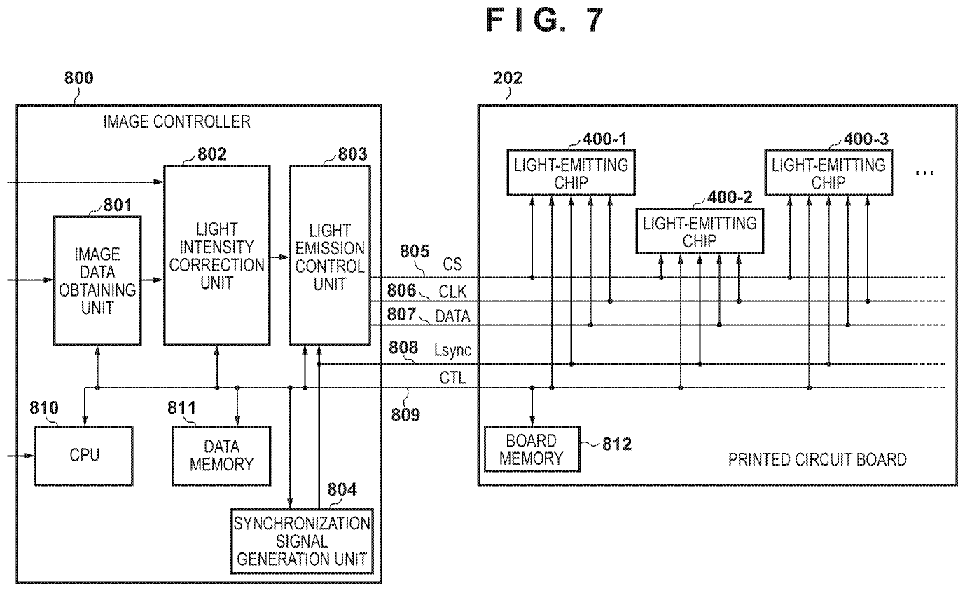

FIG. 7 shows an example of a configuration of a control circuit for controlling light emission of the light-emitting chips 400 on the printed circuit board 202. Here, processing for a single color component will be described to simplify the description; however, in practice, the same processing is performed for four color components in parallel. The image controller 800 is connected to each of the light-emitting chips 400 on the printed circuit board 202 via a plurality of signal lines 805 to 809. A chip select signal line 805 carries a chip select signal CS, which indicates an effective range of image data. A clock signal line 806 carries a clock signal CLK. A data signal line 807 carries image data. A synchronization signal line 808 carries a line synchronization signal Lsync for identifying a line period for the image data. A communication signal line 809 carries a control signal CTL.

The image controller 800 includes a control board, on which an image data obtaining unit 801, a light intensity correction unit 802, a light emission control unit 803, a synchronization signal generation unit 804, a CPU 810, and a data memory 811 are provided. On the printed circuit board 202, the plurality of light-emitting chips 400 and a board memory 812 are mounted.

The image data obtaining unit 801 obtains image data from the reading unit 100 or an external device, performs image processing on the obtained image data, and generates image data in a binary bitmap format for controlling whether each light-emitting elements 602 emits light in the light-emitting element array 201. Image processing here may include, for example, rasterization and halftoning (e.g., dithering). Image data after being subjected to halftoning is a set of bits indicating, for each pixel position constituting an image to be formed, whether or not to cause the corresponding M light-emitting elements 602 to emit light. If a bit for a certain pixel position indicates “emission”, a corresponding spot on the surface of the photosensitive member 102 will be exposed to light from M light-emitting elements 602. If this bit indicates “non-emission”, the corresponding spot will be exposed to no light. The image data obtaining unit 801 outputs the generated image data to the light intensity correction unit 802.

The light intensity correction unit 802 corrects pixel values of image data input from the image data obtaining unit 801 such that image unevenness formed on the photosensitive member 102 is suppressed. More specifically, as will be described in detail below, the light intensity correction unit 802 determines, for each image region of the image data, a correction amount for the pixel values to generate correction data that indicates the determined correction amounts. Further, the light intensity correction unit 802 modifies the generated correction data based on a predetermined limit value. Then, the light intensity correction unit 802 corrects the pixel values of the image data input from the image data obtaining unit 801 in accordance with the modified correction data. A sensor signal from the aforementioned sensor that detects the reference position of rotation of the photosensitive member 102 is input to the light intensity correction unit 802. Based on the phase of rotation of the photosensitive member 102 indicated by the sensor signal, the light intensity correction unit 802 can determine a correspondence between the image data and the correction data for image regions in the rotation direction. The light intensity correction unit 802 outputs the corrected image data to the light emission control unit 803.

Correction of pixel values of image data by the light intensity correction unit 802 typically includes, for each target pixel of the image data, changing the integrated exposure amount per unit area of a region formed from a group of pixels including the target pixel in accordance with a correction amount. Thus, the correction amounts indicated by the above correction data may be determined from the perspective of a change rate of the integrated exposure amount.

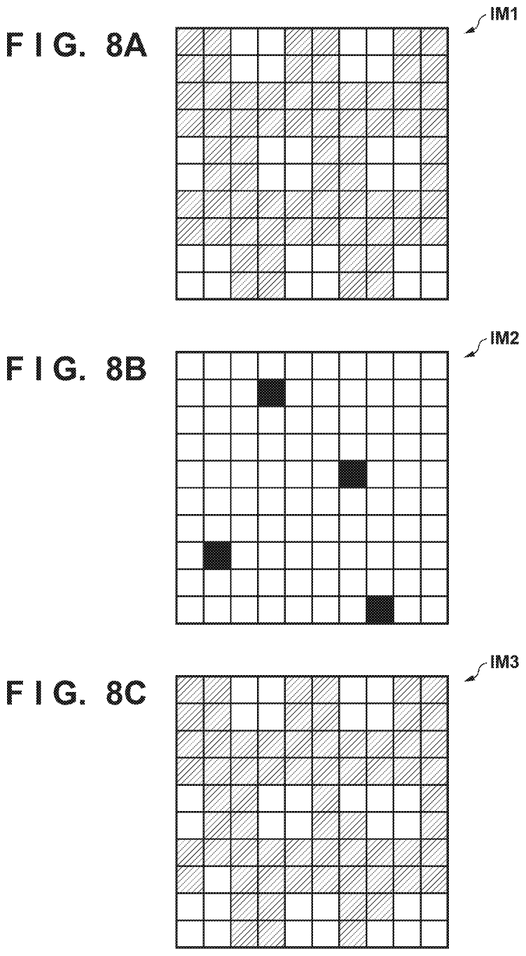

A method of locally changing the integrated exposure amount will be described below with reference to FIGS. 8A to 8C. FIG. 8A illustrates an example of a small image IM1 representing a region that includes a certain reference pixel position in the pre-correction image data. One square in the figure corresponds to one pixel. A shaded pixel indicates that a corresponding spot is an exposed dot, i.e., the corresponding M light-emitting elements emit light. A white pixel indicates that a corresponding spot is a non-exposed dot, i.e., corresponding M light-emitting elements do not emit light. Here, an x-th pixel position from the left and a y-th pixel position from the top are denoted as (x, y), with respect to the upper left pixel of the small image.

FIG. 8B shows a correction matrix IM2 as an example. The correction matrix IM2 is a matrix (bitmap) of the same size as the small image IM1, where one square in the figure corresponds to one element. Shaded elements correspond to pixels to be changed that are selected based on a measurement result of unevenness. There may be two types of correction matrices, one for reducing the light intensity and the other for increasing the light intensity, and the correction matrix IM2 is assumed to be a matrix for reducing the light intensity. As an example, if the light intensity at a reference pixel position is to be reduced by 4% relative to a maximum value, four pixels out of a total of 100 (=10*10) pixels are selected as pixels to be changed. In the example of FIG. 8B, pixels at pixel positions (4, 2), (7, 5), (2, 8), and (8, 10) are selected as the pixels to be changed. The pixel positions of pixels to be changed may be selected by comparing a target correction amount with each element of a threshold matrix table having high-spatial-frequency characteristics, for example, in accordance with the well-known blue noise mask method.

If a pixel at the same position as a pixel to be changed that is selected in the correction matrix IM2 indicates an exposed dot in the small image IM1, the light intensity correction unit 802 changes this pixel to a non-exposed dot (i.e. inverts the pixel value). FIG. 8C shows an example of the results of correcting the small image IM1 using the correction matrix IM2. In a small image IM3 shown in FIG. 8C, pixels at pixel positions (7, 5), (2, 8), and (8, 10), which were exposure dots in the small image IM1, are changed to non-exposed dots. As a result, the local integrated exposure amount in the small image IM3 is decreased from that in the small image IM1. In the case of increasing the light intensity at a reference pixel position, if a pixel at the same position as a selected pixel to be changed indicates a non-exposed dot in the small image IM1, the light intensity correction unit 802 changes this pixel to an exposed dot.

By repeatedly changing the local integrated exposure amount as described above with a correction amount indicated by the correction data for each reference pixel position that is sequentially selected along a main scanning direction, the light intensity correction unit 802 can achieve correction of the light intensity over one entire line of an image.

Although an example in which the size of a small image is 10*10 pixels has been described here, the present embodiment is not limited to this example. For example, if a pixel to be changed is selected in accordance with the blue noise mask method, setting the size of a small image to a larger size, for example 128*128 pixels or 256*256 pixels, can spread the spatial frequency more randomly to significantly suppress interference moiré.

Returning to FIG. 7, the light emission control unit 803 controls light emission of each light-emitting element 602 of the light-emitting element array 201 in accordance with a corresponding pixel value of the corrected image data that is input from the light intensity correction unit 802. More specifically, in each line period identified by a line synchronization signal Lsync, the light emission control unit 803 reads pixel values within a corresponding read range in the corrected image data and transmits image data indicating the read pixel values to the data signal line 807. Image data is, for example, a sequence of pixel values corresponding to the respective light-emitting elements 602 of the twenty light-emitting chips 400. The light emission control unit 803 designates which light-emitting chip 400 is to receive each portion of the image DATA, by means of a chip select signal CS. The light emission control unit 803 generates a clock signal CLK and supplies the generated signal to each light-emitting chip 400 in order to achieve synchronization of timings of transmitting and receiving individual signal values with the light-emitting chip 400.

The synchronization signal generation unit 804 determines delimitations between lines of the image data, generates a line synchronization signal Lsync, and supplies the generated line synchronization signal Lsync to the synchronization signal line 808. When the photosensitive member 102 rotates at a circumferential speed of 200 mm/s, for example, it is possible to form dots of each line in a pixel size of approximately 21.2 μm, which corresponds to a resolution of 1200 dpi, by setting one line period to approximately 105.8 μs.

The CPU 810 is a processor that controls exposure operations of the exposure head 106 in an integrated manner. For example, the CPU 810 controls obtainment of image data by the image data obtaining unit 801, correction of the image data by the light intensity correction unit 802, generation of a line synchronization signal by the synchronization signal generation unit 804, and transmission of the image data to the printed circuit board 202 by the light emission control unit 803. The CPU 810 is connected with a main controller (not shown) of the image-forming apparatus 1 via a communication line and realizes the smooth operation of each unit of the exposure head 106 in cooperation with the main controller.

In each line period identified by a line synchronization signal Lsync, each light-emitting chip 400 drives each of light-emitting elements 602 in accordance with the corrected image data input from the light emission control unit 803. For example, each light-emitting chip 400 receives a portion of image data that is directed to that chip via the data signal line 807 when a chip select signal CS indicates a data reception timing for that chip. Each light-emitting chip 400 then drives each of light-emitting elements 602 in the light-emitting element array in accordance with pixel values included in the received image data.

Note that each light-emitting chip 400 includes at least one reference current source (not shown) in addition to the light-emitting element array. Each reference current source supplies a current to a plurality of light-emitting elements 602 connected to the reference current source. The board memory 812 may store current setting data indicating a current amount to be supplied from each reference current source. The number of reference current sources included in each light-emitting chip 400 depends on the interconnect length within the chip or the driving capability of the reference current source, and may be any number greater than or equal to one.

### <4-2. Suppression of Unevenness by Correction of Image Data>

Unevenness may occur in the light intensity of irradiation from the light-emitting element array of the exposure apparatus employing a solid-state exposure system to the photosensitive member due to various causes, including individual differences between light-emitting chips, individual differences between light-emitting elements in a light-emitting chip, local errors of the rod lens array, and the like. Japanese Patent Laid-Open No.2024-147996 discloses a technology that measures light intensity unevenness in advance and corrects image data for light emission control based on the measurement results so as to suppress the light intensity unevenness. However, image unevenness formed on the photosensitive member includes density unevenness due to the characteristics of the photosensitive member as well as unevenness in the amount of light irradiated to the photosensitive member. For example, if the sensitivity of the photosensitive member spatially varies, even exposing the photosensitive member to uniform light does not result in an electrostatic latent image having a uniform electric potential on the surface of the photosensitive member. Further, if the rotation axis of the photosensitive member is biased or its cross-sectional shape is not a perfect circle, that is, if the photosensitive member is eccentric, the spacing between the surface of the photosensitive member and the developer fluctuates during one rotation cycle of the photosensitive member, which results in variation in the development performance. The variation in the development performance due to the eccentricity of the photosensitive member causes density unevenness in the rotation direction of the photosensitive member.

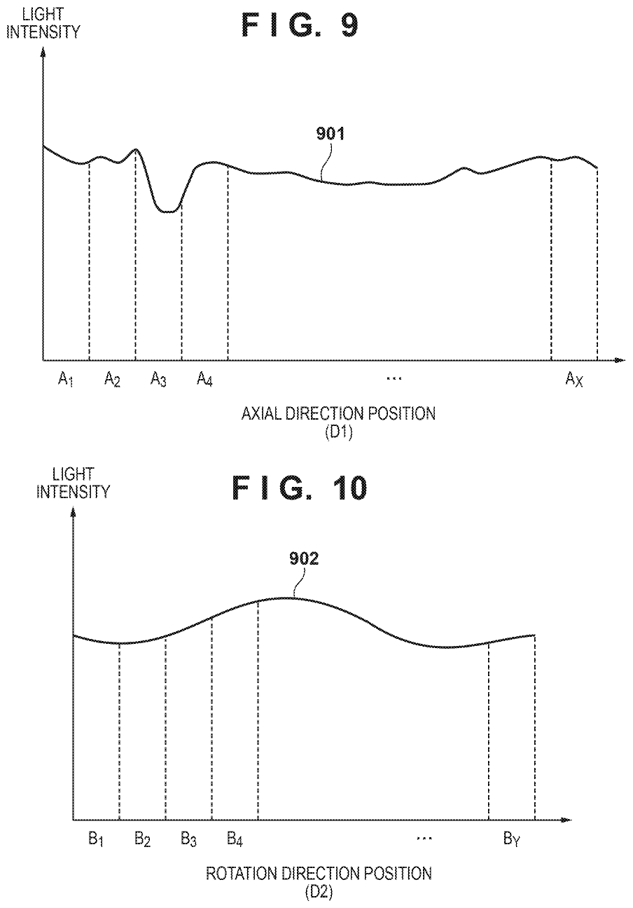

FIG. 9 shows a graph 901 representing an example of a measurement result of the light intensity unevenness of the light-emitting element array along the axial direction (first direction D1) of the photosensitive member. The horizontal axis of the graph 901 represents positions in the axial direction in the photosensitive member, and the vertical axis represents measured light intensity. When the multiple exposure described with reference to FIG. 6 is performed, the light intensity on the vertical axis may represent accumulated values of the light intensity of irradiation from M light-emitting elements. When the entire length of the light-emitting element array in the axial direction is segmented into X segments A₁ to A_{X}, the graph 901 shows locally significantly low light intensity in the segment A₃ in the illustrated example. If an image is formed by using this light-emitting element array without correction of light intensity to expose the photosensitive member to light, there is a high possibility of image quality deterioration appearing in a linear pattern at a position corresponding to the segment A₃. The light intensity unevenness of a light-emitting element array may be measured by forming, on a sheet, an image of a correction chart (chart image) described in Japanese Patent Laid-Open No.2024-147996, for example, and optically reading the formed chart image.

FIG. 10 shows a graph 902 representing an example of a measurement result of the density unevenness along the rotation direction (second direction D2) of the photosensitive member. The horizontal axis of the graph 902 represents positions in the rotation direction of the photosensitive member (also referred to as phase), and the vertical axis represents measured light intensity. The entire length corresponding to one rotation cycle of the photosensitive member is segmented into Y segments B₁ to B_{Y} in the illustrated example. The graph 902 shows moderate fluctuation in the light intensity over the segments B₁ to B_{Y}. The density unevenness of a photosensitive member may be measured by forming, on a sheet, a chart image that spans the length of one rotation cycle from the reference position on the outer periphery of the photosensitive member and optically reading the formed chart image.

It is conceivable to measure the unevenness in the amount of light irradiated from a light-emitting element array and the unevenness of density due to the characteristics of a photosensitive member in advance, and correct image data for light emission control so as to suppress both of the light intensity unevenness and the density unevenness. However, a too large degree of the compound unevenness leads to an excessive correction amount, which instead may cause image quality deterioration such as dot shape deformation. On the other hand, imposing a local limit on the correction amount results in noticeable streak-like image defects due to a correction error in boundaries of a region to which the limit is applied.

Thus, in the present embodiment, the light intensity correction unit 802 modifies not only a correction amount for a specific region in which the correction amount exceeds a predetermined limit value, but also a correction amount for an adjacent region of the specific region. This can avoid excessive correction while keeping subjective deficiencies in the image quality due to a correction error unnoticeable.

Typically, a correction amount is determined at least per image region having a size larger than or equal to the size of a region that is a unit for calculating the integrated exposure amount. For example, when the length of the photosensitive member in the rotation direction is segmented into seven segments and the length of the light-emitting element array in the axial direction is segmented into ten segments, 7*10=70 image regions are obtained. Correction data generated by the light intensity correction unit 802 indicates a correction amount (change rate of the integrated exposure amount) determined for each of these respective image regions.

The data memory (first memory unit) 811 of the image controller 800 shown in FIG. 7 stores density unevenness data in advance based on measurement results for light amount unevenness of density measured in advance in a factory for the photosensitive member 102. The board memory (second memory unit) 812 of the printed circuit board 202 stores light intensity unevenness data in advance based on measurement results for light amount unevenness measured in advance in the factory for the light-emitting element array of the printed circuit board 202. The light intensity correction unit 802 determines a correction amount for each image region based on the density unevenness data read from the data memory 811 and the light intensity unevenness data read from the board memory 812 to generate correction data. The light intensity correction unit 802 may partially reduce the light intensity unevenness in the axial direction of the photosensitive member 102 by adjusting the current amount from the reference current source of each light-emitting chip 400, and suppress residual components of the adjusted light intensity unevenness by correcting image data.

The correction data generated by the light intensity correction unit 802 is data in a matrix form. Each row of the correction data indicates respective correction amounts of a plurality of image regions at different positions in the axial direction of the photosensitive member 102. Each column of the correction data indicates respective correction amounts of a plurality of image regions at different positions in the rotation direction of the photosensitive member 102. For example, each column of the correction data indicates respective correction amounts of a plurality of image regions over the length of one rotation cycle of the photosensitive member 102 with the reference position on the outer periphery of the photosensitive member 102 as a reference. The light intensity correction unit 802 determines, for each pixel value of the image data, which correction amount of an image region in each column of the correction data to refer to for correcting the pixel value, based on the phase of rotation (rotation angle from the reference position) of the photosensitive member 102 indicated by a sensor signal mentioned above.

The light intensity correction unit 802 generates tentative correction data based on the density unevenness data and the light intensity unevenness data and determines whether or not the correction amount for each image region exceeds the predetermined limit value. The limit value may be set in a fixed manner, or may be changeable by a user. Then, when the correction amount of a first image region exceeds the limit value, the light intensity correction unit 802 modifies the correction amount of the first image region to a value that does not exceed the limit value and modifies correction amounts of one or more other image regions including an adjacent image region of the first image region in accordance with the modification to the correction amount of the first image region. Some variations of modification to the correction amounts of the image regions other than the first image region will be further described below.

### <4-3. Example of Density Unevenness Data and Light Intensity Unevenness Data>

The density unevenness data may be, for example, an array of values of correction amounts for cancelling out the density unevenness and uniformizing the density for Y image regions in the rotation direction of the photosensitive member 102. In a certain embodiment, the light intensity unevenness data may be an array of values of correction amounts for cancelling out the light intensity unevenness (or residual components thereof) and uniformizing the light intensity for X image regions in the axial direction of the photosensitive member 102. In another embodiment, the light intensity unevenness data may have the following two types of data items, for example.
Correction amount A: indicates a correction amount component common to light-emitting elements which are supplied with a current from the same reference current source.
Correction amount B: indicates correction amounts that are residuals after deducting the correction amount A.

Generally, as the variation in the light intensity of the light-emitting elements that are supplied with a current from the same reference current source is small, describing a correction amount divided into two types of data items with different granularities like this can suppress the data size of the entirety of correction data.

In another embodiment, the light intensity unevenness data may further have an additional data item, which is a spot correction amount C. For example, if the spot size on an imaging plane of light from the exposure head 106 enlarges due to manufacturing variation, the density of a printed image in a low gradation domain becomes lower relative to an equivalent gradation value because of insufficient light intensity. Meanwhile, if the spot size enlarges, the density of a printed image in a high gradation domain becomes higher relative to an equivalent gradation value because adjoining spots coalesce. In the following description, an imaging spot with an enlarged size is referred to as an abnormal spot. The density in an intermediate gradation domain is hardly affected by the abnormal spot. The spot correction amount C may indicate the position of each of abnormal spots detected in measurement results of the light intensity unevenness and a spot size deviation amount (a difference between a reference value and the spot size) at each abnormal spot.

### <4-4. Specific Configuration Example of Light Intensity Correction Unit>

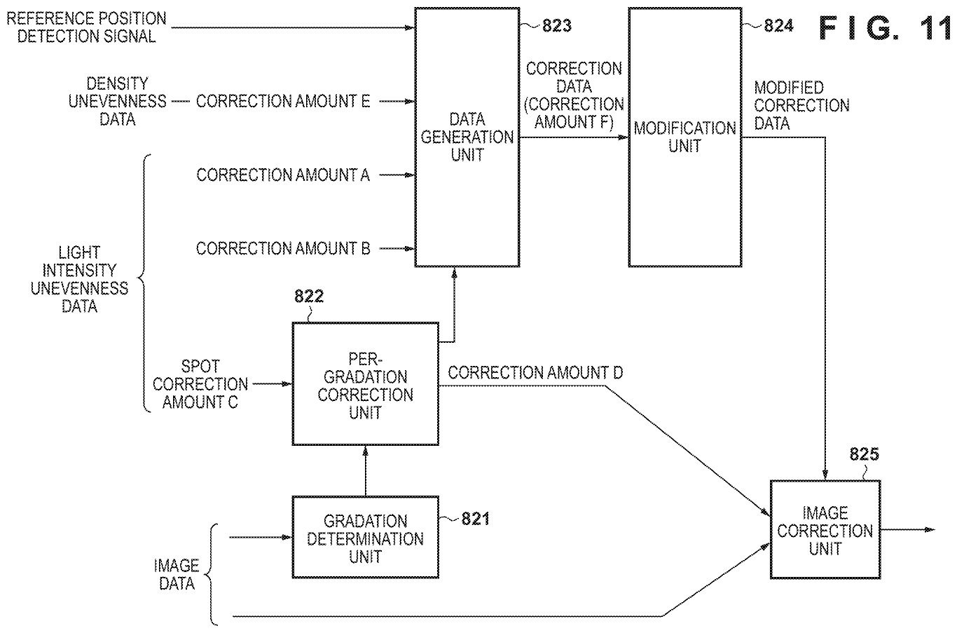

FIG. 11 shows an example of a detailed configuration of the light intensity correction unit 802 in a case where the light intensity unevenness data includes the correction amount A, the correction amount B, and the spot correction amount C. With reference to FIG. 11, the light intensity correction unit 802 includes a gradation determination unit 821, a per-gradation correction unit 822, a data generation unit 823, a modification unit 824, and an image correction unit 825.

The gradation determination unit 821 determines a gradation domain at each pixel position based on input image data. For example, the gradation determination unit 821 focuses on a patch image that includes a pixel (target pixel) at each pixel position and neighboring pixels, and determines whether the gradation of the target pixel falls within the low gradation domain, the intermediate gradation domain, or the high gradation domain, based on the integrated exposure amount (e.g. average pixel value) in the patch image. For example, if the integrated exposure amount in the patch image is greater than a first threshold, the gradation domain of the target pixel is classified as the high gradation domain. If the integrated exposure amount in the patch image is smaller than or equal to the first threshold and greater than a second threshold (first threshold>second threshold), the gradation domain of the target pixel is classified as the intermediate gradation domain. If the integrated exposure amount in the patch image is smaller than or equal to the second threshold, the gradation domain of the target pixel is classified as the low gradation domain. The gradation determination unit 821 notifies the per-gradation correction unit 822 of the results of determining the gradation domain for each pixel position.

The per-gradation correction unit 822 has a correction table that holds a reference correction amount which is predetermined for each of the high gradation domain, the intermediate gradation domain, and the low gradation domain. Generally, the reference correction amount for the high gradation domain indicates a negative correction amount, and the sign thereof being negative means that the light intensity is to be decreased. The reference correction amount for the low gradation domain indicates a positive correction amount, and the sign thereof being positive means that the light intensity is to be increased. The reference correction amount for the intermediate gradation domain may be zero. The per-gradation correction unit 822 obtains, by referring to the correction table, the reference correction amount corresponding to the gradation domain of which the per-gradation correction unit 822 is notified by the gradation determination unit 821 for each of the pixel positions of the abnormal spots indicated by the spot correction amount C. Next, the per-gradation correction unit 822 calculates a correction amount D based on the obtained reference correction amount and the spot size deviation amount indicated by the spot correction amount C. For example, the correction amount D may be the product of the reference correction amount and a coefficient corresponding to the spot size deviation amount. To calculate the correction amount D, the per-gradation correction unit 822 may have a coefficient table or a relational expression that defines a relationship between the spot size deviation amount and the coefficient. The per-gradation correction unit 822 then outputs the calculated correction amount D to the data generation unit 823 when the sign thereof is negative and to the image correction unit 825 when the sign thereof is positive. Note that the correction amount D may be zero for a pixel position where no abnormal spot is detected.

It should be noted that the light intensity unevenness data may not include the spot correction amount C, and in that case, the gradation determination unit 821 and the per-gradation correction unit 822 may be omitted from the configuration of the light intensity correction unit 802.

The data generation unit 823 obtains, for each of the image regions arranged in the first direction D1, the correction amount A and the correction amount B for the image region from the light intensity unevenness data. Further, the data generation unit 823 obtains, for each image region, a correction amount E corresponding to the rotational phase of the photosensitive member 102 from the density unevenness data. The data generation unit 823 then determines a correction amount F for each image region based on the correction amount A, the correction amount B, the correction amount D, and the correction amount E, and generates correction data that indicates the determined correction amount F. Typically, the correction amount F indicates zero or a negative value, and may be the sum of the correction amount A, the correction amount B, the correction amount D, and the correction amount E. The data generation unit 823 outputs the correction data to the modification unit 824.

The modification unit 824 determines whether or not the correction amount F for each image region indicated by the correction data exceeds the predetermined limit value. When the correction amount F of a first image region exceeds the limit value, the modification unit 824 modifies the correction amount F of the first image region to a correction amount that does not exceed the limit value. Further, the modification unit 824 modifies correction amounts of one or more other image regions including an adjacent image region of the first image region in accordance with the modification to the correction amount of the first image region. When the correction amount F of a second image region is modified in accordance with the modification to the correction amount F of the first image region, the modification unit 824 performs, for the second image region, further modification only when its modified correction amount exceeds the limit value so that duplicate modification is avoided.

In a first embodiment, the modification unit 824 may modify the correction amounts of all of the other image regions that belong to the same row as the first image region in accordance with the modification to the correction amount of the first image region. At this time, the modification unit 824 may modify the correction amounts of all of the image regions that belong to the same row as the first image region by a uniform modification rate or modification amount. Alternatively, the modification unit 824 may modify the correction amounts of all of the other image regions that belong to the same row as the first image region by a modification rate or modification amount that becomes smaller as the distance from the first image region becomes larger.

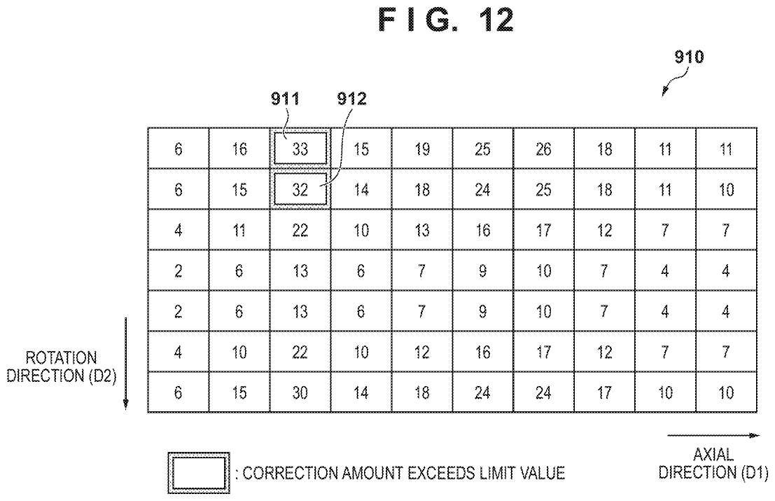

FIG. 12 is a descriptive diagram illustrating an example of pre-modified correction data 910 that indicates correction amounts determined such that image unevenness is suppressed. The correction data 910 in the example of FIG. 12 is data in a matrix form of seven rows and ten columns. Each row of the correction data 910 indicates correction amounts determined for ten image regions in the axial direction of the photosensitive member 102 by the data generation unit 823 based on the density unevenness data and the light intensity unevenness data. Each column of the correction data 910 indicates correction amounts determined for seven image regions in the rotation direction of the photosensitive member 102 by the data generation unit 823 based on the density unevenness data and the light intensity unevenness data. The value of the correction amount for each image region in the figure indicates, for example, a target percentage decrease in the integrated exposure amount within that image region. Here, it is assumed that the value of 30% is set as the limit value for avoiding excessive modification. In the example of FIG. 12, the correction amount exceeds the limit value in image regions 911 and 912 with thick borders among a total of seventy image regions. Note that the matrix size of seven rows and ten columns of the correction data 910 is merely a simple example for explanation. It is possible to suppress the unevenness in a finer manner by segmenting an image of the same size into a larger number of image regions.

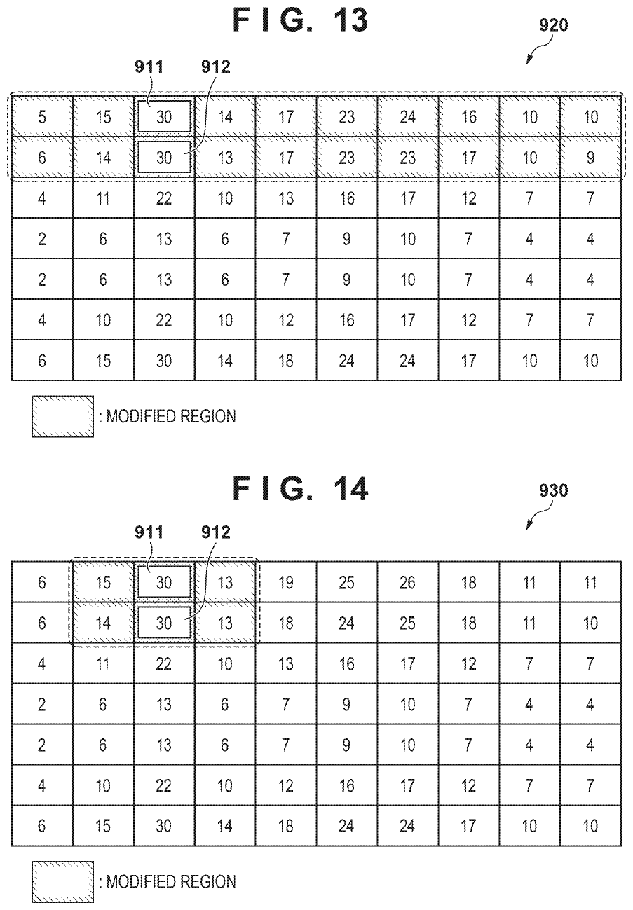

FIG. 13 is a descriptive diagram illustrating an example of modified correction data 920 in the first embodiment. In the correction data 920, the correction amount of the image region 911, which exceeds the limit value in the correction data 910, is modified to a value equal to the limit value. In addition, the correction amounts of all of the other image regions that belong to the same row as the image region 911 are modified by a modification rate that is the same as the modification rate for the correction amount of the image region 911. The modification rate here is equal to 30/33. Further, the correction amount of the image region 912, which exceeds the limit value in the correction data 910, is modified to a value equal to the limit value. In addition, the correction amounts of all of the other image regions that belong to the same row as the image region 912 are modified by a modification rate that is the same as the modification rate for the correction amount of the image region 912. The modification rate here is equal to 30/32. However, since the integrated exposure amount takes discrete values as understood from the description of FIGS. 8A to 8C, the correction amounts are also constrained by the discrete values of the integrated exposure amount, and the minimum unit of the correction amounts here is 1%. Thus, a substantive modification rate is not always uniform as a result of rounding, and the modification amount may be zero in some image regions.

By modifying correction amounts of a plurality of image regions over the entirety of the axial direction of the photosensitive member 102 as in the first embodiment, it is possible to prevent streak-like image defects due to a correction error from appearing in a printed image. In addition, by applying a uniform modification rate or modification amount to the correction amounts of those image regions, it is possible to minimize the light intensity unevenness in the axial direction.

In a second embodiment, the modification unit 824 may modify the correction amounts of one or more other image regions that belong to the same row as the first image region and are adjacent to the first image region in accordance with the modification to the correction amount of the first image region. At this time, the modification unit 824 may modify the correction amounts of all of the adjacent image regions that belong to the same row as the first image region by a uniform modification rate or modification amount. Alternatively, the modification unit 824 may modify the correction amounts of the adjacent image regions that belong to the same row as the first image region by a modification rate or modification amount that becomes smaller as the distance from the first image region becomes larger.

FIG. 14 is a descriptive diagram illustrating an example of modified correction data 930 in the second embodiment. In the correction data 930, the correction amount of the image region 911, which exceeds the limit value in the correction data 910, is modified to a value equal to the limit value. In addition, the correction amounts of two image regions adjacent to the image region 911 are modified in accordance with the modification to the correction amount of the image region 911. Further, the correction amount of the image region 912, which exceeds the limit value in the correction data 910, is modified to a value equal to the limit value. In addition, the correction amounts of two image regions adjacent to the image region 912 are modified in accordance with the modification to the correction amount of the image region 912.

By modifying not only a correction amount of an image region that exceeds the limit value but also correction amounts of adjacent image regions as in the second embodiment, it is possible to prevent streak-like image defects due to a correction error from becoming noticeable in a printed image. In addition, by making the degree of modification for an image region smaller as it is further away from the image region whose correction amount exceeds the limit value, an increase or decrease of a correction error is slowed down in the axial direction, so that the possibility of the impact of the correction error being subjectively perceived can be further reduced.

The modification unit 824 outputs the correction data modified in accordance with any of the above embodiments to the image correction unit 825.

The image correction unit 825 determines a scaling rate of light intensity in each image region based on the correction amount D input from the per-gradation correction unit 822 and the modified correction data input from the modification unit 824. The image correction unit 825 further corrects image data of each image region (changes pixel values constituting a corresponding small image) so as to increase or decrease the integrated exposure amount in the image region in accordance with the method described with reference to FIGS. 8A to 8C. The image correction unit 825 then outputs the corrected image data to the light emission control unit 803.

In the present embodiment, image unevenness is suppressed by changing pixel values of image data before outputting data from the light emission control unit 803 to each light-emitting chip 400. Therefore, the light emission control unit 803 can distribute the image data to each light-emitting chip 400 by a common control logic without being influenced by the unevenness of the image.

It should be noted that, although an example in which the data generation unit 823 of the light intensity correction unit 802 generates pre-modified correction data based on the density unevenness data and the light intensity unevenness data has been described here, the CPU 810 may generate the pre-modified correction data instead of the data generation unit 823. While the density unevenness data is stored in the memory on the control board, the light intensity unevenness data is stored in the memory on the light-emitting board on which the light-emitting element array is mounted. Therefore, when the light-emitting board is replaced for some reason such as malfunction of the light-emitting element array, correction data can be generated again depending on a combination of the light intensity unevenness specific to a new light-emitting board and the density unevenness due to the characteristics of the photosensitive member.

### 5. Conclusion

So far, various embodiments and embodiments of the technology according to the present disclosure have been described in detail with reference to FIGS. 1 to 14. According to the above embodiments, in an exposure apparatus employing a solid-state exposure system, a correction amount is determined for each image region such that image unevenness is suppressed, the determined correction amount is modified based on a predetermined limit value, and pixel values of image data for light emission control are corrected in accordance with the modified correction amount. Among others, when a correction amount of a first image region exceeds the limit value, not only the correction amount of the first image region is modified to a value that does not exceed the limit value but also correction amounts of one or more other image regions including an adjacent image region of the first image region are modified in accordance with the modification to the correction amount of the first image region. Therefore, in circumstances where unevenness in the amount of light irradiated to a photosensitive member and unevenness of density due to the characteristics of a photosensitive member affect image quality in a mixed manner, it is possible to avoid deterioration of the image quality due to excessive correction as well as to prevent a situation in which the local limitation of the correction amount causes noticeable deficiencies in the image quality due to a correction error.

In the above embodiments, a correction amount for each image region is represented by correction data in a matrix form. Each row of the correction data indicates respective correction amounts of a plurality of image regions at different positions in a first direction parallel to the rotation axis of the photosensitive member, and each column indicates respective correction amounts of a plurality of image regions at different positions in the rotation direction of the photosensitive member. Then, when a correction amount of a first image region exceeds a limit value, correction amounts of other image regions that belong to the same row as the first image region are modified in accordance with the modification to the correction amount of the first image region. That is, the range to which modification to a correction amount is applied is mainly expanded in the first direction parallel to the rotation axis of the photosensitive member and is not expanded in the rotation direction of the photosensitive member. Here, density unevenness due to the characteristics of the photosensitive member generally tends to appear as moderate fluctuation in density during one rotation cycle. Thus, even if the range to which modification to a correction amount is applied is not expanded in the rotation direction of the photosensitive member, subjective deficiencies in the image quality due to a correction error will not become noticeable. Instead, by the modification to correction amounts with the limitation described above, it is possible to achieve both suppression of image unevenness and prevention of an adverse effect from correction of image data so that the image quality of printed images can be optimized.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-083514, filed May 19, 2025, which is hereby incorporated by reference herein in its entirety.

What is claimed is:

1. An exposure apparatus configured to expose a rotating photosensitive member to light in accordance with image data, the exposure apparatus comprising:
a light-emitting element array that includes a plurality of light-emitting elements arranged at least in a first direction that is parallel to a rotation axis of the photosensitive member,
a generation unit configured to generate correction data that indicates a correction amount determined for each image region of the image data such that image unevenness formed on the photosensitive member is suppressed,
a correction unit configured to modify the correction data generated by the generation unit based on a predetermined limit value and correct pixel values of the image data in accordance with the modified correction data, and
a light emission control unit configured to control light emission from each light-emitting element of the light-emitting element array in accordance with the image data corrected by the correction unit,
wherein the correction unit is configured to, in a case where a correction amount of a first image region exceeds the limit value,
modify the correction amount of the first image region to a value that does not exceed the limit value, and
modify correction amounts of one or more other image regions including an adjacent image region of the first image region in accordance with the modification to the correction amount of the first image region.

2. The exposure apparatus according to claim 1, wherein the correction data is data in a matrix form,
each row of the correction data indicates respective correction amounts of a plurality of image regions at different positions in the first direction, and
each column of the correction data indicates respective correction amounts of a plurality of image regions at different positions in a rotation direction of the photosensitive member.

3. The exposure apparatus according to claim 2, wherein the correction unit is configured to modify correction amounts of all of the other image regions that belong to the same row as the first image region in accordance with the modification to the correction amount of the first image region.

4. The exposure apparatus according to claim 2, wherein the correction unit is configured to modify correction amounts of one or more other image regions that belong to the same row as the first image region and are adjacent to the first image region in accordance with the modification to the correction amount of the first image region.

5. The exposure apparatus according to claim 3, wherein the correction unit is configured to modify correction amounts of the image regions that belong to the same row as the first image region by a uniform modification rate or modification amount.

6. The exposure apparatus according to claim 4, wherein the correction unit is configured to modify correction amounts of the one or more other image regions that belong to the same row as the first image region by a modification rate or modification amount that becomes smaller as a distance from the first image region becomes larger.

7. The exposure apparatus according to claim 1, wherein the unevenness of the image includes unevenness of density due to characteristics of the photosensitive member and unevenness in the amount of light irradiated from the light-emitting element array.

8. The exposure apparatus according to claim 7, wherein the characteristics of the photosensitive member include at least one of spatial variation in sensitivity of the photosensitive member and eccentricity of the photosensitive member.

9. The exposure apparatus according to claim 7, further comprising:
a first memory unit configured to store, in advance, density unevenness data that is based on a measurement result of the unevenness of density; and
a second memory unit configured to store light amount unevenness data that is based on a measurement result of the unevenness of light intensity in advance,
wherein the generation unit is configured to determine a correction amount for each image region based on the density unevenness data and the light intensity unevenness data.

10. The exposure apparatus according to claim 9, further comprising:
a control board on which the generation unit, the correction unit, the light emission control unit, and the first memory unit are provided; and
a light-emitting board on which the light-emitting element array and the second memory unit are provided.

11. The exposure apparatus according to claim 1, wherein the correction of the pixel values of the image data by the correction unit includes changing the integrated exposure amount per unit area of a region consisting of a group of pixels in accordance with a correction amount indicated by the modified correction data.

12. The exposure apparatus according to claim 2, wherein each column of the correction data indicates respective correction amounts of the plurality of image regions over a length of one rotation cycle of the photosensitive member, with the reference position on the outer periphery of the photosensitive member as a reference.

13. The exposure apparatus according to claim 12, wherein the correction unit is configured to determine, for each pixel value of the image data, which correction amount of an image region in each column of the correction data to refer to for correcting the pixel value, based on a phase of rotation indicated by a signal from a sensor that detects a reference position of the rotation of the photosensitive member.

14. An image-forming apparatus comprising a photosensitive member and an exposure unit configured to expose the rotating photosensitive member to light in accordance with image data,
wherein the exposure unit includes
a light-emitting element array that includes a plurality of light-emitting elements arranged at least in a first direction that is parallel to a rotation axis of the photosensitive member,
a generation unit configured to generate correction data that indicates a correction amount determined for each image region of the image data such that image unevenness formed on the photosensitive member is suppressed,
a correction unit configured to modify the correction data generated by the generation unit based on a predetermined limit value and correct pixel values of the image data in accordance with the modified correction data, and
a light emission control unit configured to control light emission from each light-emitting element of the light-emitting element array in accordance with the image data corrected by the correction unit,
wherein the correction unit is configured to, in a case where a correction amount of a first image region exceeds the limit value,
modify the correction amount of the first image region to a value that does not exceed the limit value, and
modify correction amounts of one or more other image regions including an adjacent image region of the first image region in accordance with the modification to the correction amount of the first image region.
